(19) United States
(12) Patent Application Publication
(10) Pub. No.: US 2010/0121663 A1
(43) Pub. Date: May 13, 2010

(54) System and Method for Maintaining Displayed Pricing at Retail Stores

(76) Inventor: Francisco M. Valeriano, Torrance, CA (US)

Correspondence Address: ALIX, YALE & RISTAS, LLP, 750 MAIN STREET, SUITE 1400, HARTFORD, CT, 06103-2721, US

(21) Appl. No.: 12/270,185

(22) Filed: Nov. 13, 2008

(51) Int. Cl. G06F 17/30; G06Q 10/00

(52) U.S. Cl. 705/7; 705/1.1

(57) ABSTRACT

A system for maintaining displayed pricing at retail stores includes a computer, a printer, an EDSD reader or an EDSD reader/encoder, and at least one portable EDSD reader. The computer includes a database having a record of each product for which displayed pricing will be maintained. Each such record includes a unique identifier for the product and the current price for the product. The printer is in communication with the computer, and is adapted to generate printed pricing material on EDSD enabled media. The EDSD reader or EDSD reader/encoder is associated with the printer. Printed pricing material is generated by obtaining the current price from the product record in the product pricing database, printing the current price on EDSD enabled media, and associating an identifier stored in the EDSD with the product. The printed pricing material is then installed in the store.

### BACKGROUND

This disclosure relates generally to systems and methods for retail inventory control. More particularly, the present disclosure relates to systems and methods for maintaining the displayed pricing of retail inventory.

Inaccuracies between the advertised price and the price charged at scanners/registers are a serious problem in the retail industry. The best known manifestation of this problem occurs when retail customers are overcharged. Customer satisfaction, lost sales, fines, and time spent by employees dealing with these problems are some of the cost of overcharging. Surveys indicate that consumers lose more than $1 billion to overcharging each year.

Undercharging of customers may be more common than overcharging, but is not as well known because customers don't complain when this happens. It is estimated that retail stores lose more money from undercharging than what they make from overcharging.

Pricing discrepancies are generally attributable to human error and/or the lag time between the decision to change the price of a product and posting the new price on the product. Changing the price of a product in the store's inventory control system is substantially instantaneous, whereas changing the price displayed on the products in the store may take a significant amount of time. The scanning problems occur when the store fails to update the price displayed in the shelves and other areas as well as price stickers in the products themselves at the same time as prices change in the computer systems.

The typical process for updating retail product prices generally requires an employee to periodically walk through the store with a handheld bar code scanner/printer, scanning the bar codes printed in the labels used for displaying prices in the shelves. In some cases, the employee may be helped by computer reports indicating the prices that had changed. If an update is needed, a portable printer is used to print a new label that the employee would place in the shelf and/or products. This process usually does not cover updating the promotional material that displays pricing information for sales. This method is extremely labor intensive.

A few solutions have been proposed to improve the process of maintaining retail product pricing. One such proposal is to utilize electronic shelves that display the price in an LCD type of device. The LCD display would show the price stored in the same database that is used at the registers/scanners. However, this system addresses only the prices displayed on the shelves, and it is expensive to implement throughout a store. Electronic paper banners for displaying of promotional information has also been proposed. However, this system would be expensive to implement. In addition, the communication mechanism between the e-paper banner and the central computer limits the placement of the e-paper banners in the store. Further, the color range that may be produced by both of these technologies is limited compared to conventional ink and paper displays. Many retailers utilize the color of the promotional material to target specific customers. Accordingly, the limited color range of the LCD display and e-paper banner may limit acceptance of these technologies

### SUMMARY

There is provided a system for maintaining displayed pricing at retail stores. The system comprises a computer, a printer, an EDSD reader or an EDSD reader/encoder, and at least one portable EDSD reader. The computer includes a database having a record of each product for which displayed pricing will be maintained. Each such record includes a unique identifier for the product and the current price for the product. The printer is in communication with the computer, and is adapted to generate printed pricing material on EDSD enabled media. The EDSD reader or EDSD reader/encoder is associated with the printer. The system may further comprise at least one portable printer.

The EDSD reader or EDSD reader/encoder associated with the printer, the portable EDSD reader and the portable printer may be in communication with the computer.

The system may also comprise one or more satellite computers having a copy of the database stored therein. A satellite printer in communication with the satellite computer is adapted to generate printed pricing material on EDSD enabled media. An EDSD reader or an EDSD reader/encoder is associated with the satellite printer.

The portable EDSD reader may have a copy of the database stored therein. The portable printer may have a copy of the database stored therein.

The system may further comprise a locating system adapted to determine the location of a specific EDSD.

There is also provided a method of maintaining displayed pricing at retail stores. The method comprises maintaining a product pricing database. The database includes a record of each product for which displayed pricing will be maintained. Each such record includes a unique identifier for the product and a current price for the product. Printed pricing material is generated, including obtaining the current price from the product record in the product pricing database, printing the current price on EDSD enabled media, and associating an identifier stored in the EDSD with the product. The printed pricing material is then installed in the store.

Associating the identifier may comprise reading the identifier stored in the EDSD with an EDSD reader device associated with the printer and storing the identifier in a field of the product record.

Associating the identifier may comprise retrieving a unique identifier of the product from the database and encoding the product identifier in the EDSD. Associating the identifier may further comprise retrieving the current price of the product from the database and encoding the current price in the EDSD.

The method may further comprise passing a portable EDSD reader through the store. As the portable EDSD reader passes through the store, each EDSD that comes within range of the portable EDSD reader is queried. The product pricing database is queried for the current price of the products associated with the EDSD identifiers, and the current price of the products is compared to the price on the installed printed pricing materials. If the price printed on the installed printed pricing materials is not the same as the current price for the product, new printed pricing materials are generated.

The method may further comprise passing a portable EDSD reader through the store. As the portable EDSD reader passes through the store, the identifier stored in each EDSD that comes within range of the portable EDSD reader is read. The product pricing database is queried for the current price of the products associated with the EDSD identifiers, and the current price is displayed on the portable EDSD reader. The operator visually compares the current price of the products to the price on the installed printed pricing materials. If the price printed on the installed printed pricing materials is not the same as the current price for the product, new printed pricing materials are generated.

The method may further comprise passing a portable EDSD reader through the store. As the portable EDSD reader passes through the store, the identifier and the price stored in each EDSD that comes within range of the portable EDSD reader are read. The product pricing database is queried for the current price of the products associated with the EDSD identifiers. The current price of the products is compared to the price stored in the EDSDs of the installed printed pricing materials. If the price printed on the installed printed pricing materials is not the same as the current price for the product, new printed pricing materials are generated.

### BRIEF DESCRIPTION OF THE DRAWINGS

The present disclosure may be better understood and its numerous objects and advantages will become apparent to those skilled in the art by reference to the accompanying drawings in which:

FIG. 1 is a schematic diagram of a first embodiment of a system for maintaining displayed pricing at retail stores;

FIG. 2 is a schematic diagram of a second embodiment of a system for maintaining displayed pricing at retail stores;

FIG. 3 is a flow diagram of a method for maintaining displayed pricing at retail stores;

FIG. 4 is a flow diagram of the printed pricing material generation routine of FIG. 3; and

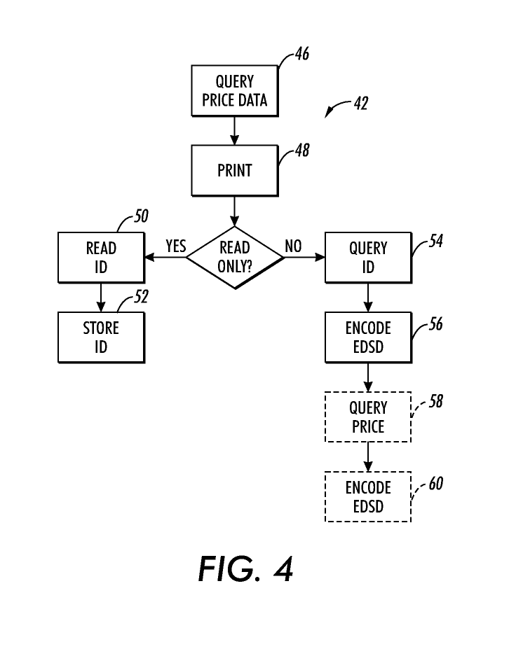

FIG. 5 is a flow diagram of the printed pricing material maintenance routine of FIG. 3.

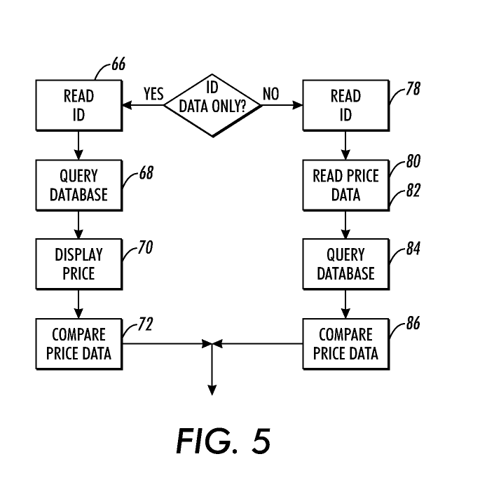

### DETAILED DESCRIPTION

In a system 10, 10′ for maintaining displayed pricing at retail stores in accordance with the present disclosure, an electronic data storage device (EDSD) 12 is embedded in, or attached to each piece of printed pricing material 14. The EDSD 12 in each piece of printed pricing material 14 contains data that read by an EDSD reader 16 and compared to a database 18 of current pricing information to verify that the price displayed to the customer is the current price for the product associated with the printed pricing material 14.

Printed pricing material 14 is hereby defined to be printed material that may be placed throughout a retail store that shows, either explicitly or implicitly, pricing information to the customers of the store. Printed pricing material may include price tags that are attached to shelves carrying the related product, price tags attached to the products, promotional material describing a promotional event, etc.

An “electronic data storage device” 12 is a machine-readable device capable of storing electronic data. An EDSD 12 may also be machine-writeable. Electronic data storage device 12 refers to a single electronic data storage device as well as to a collection of two or more electronic data storage devices connected, for example, in series, in parallel, or nested one within another. Examples of electronic data storage devices include, but are not limited to, radio frequency identification tags (RFID tags), proximity (Prox) tags, iButtons, smartcards, and similar devices. Radio frequency identification (RFID) is a method of remotely storing and retrieving data using devices called RFID tags/transponders. An RFID tag is a small object, such as an adhesive sticker, that can be attached to or incorporated into a product. RFID tags contain antennas to enable them to receive and respond to radio-frequency queries from an RFID transceiver.

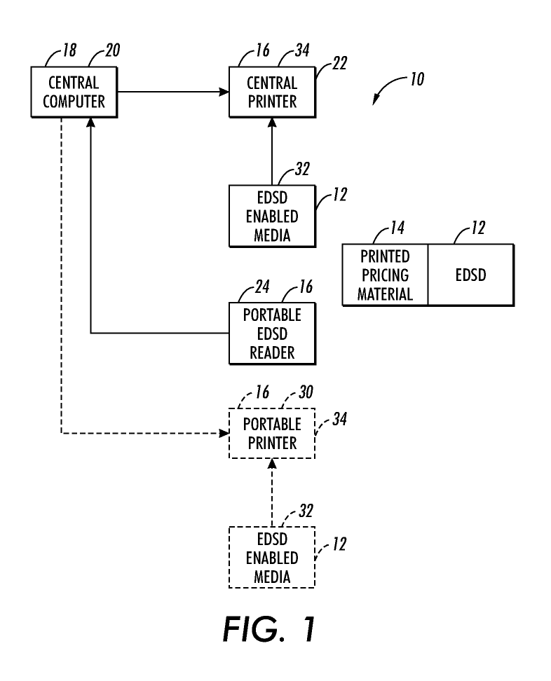

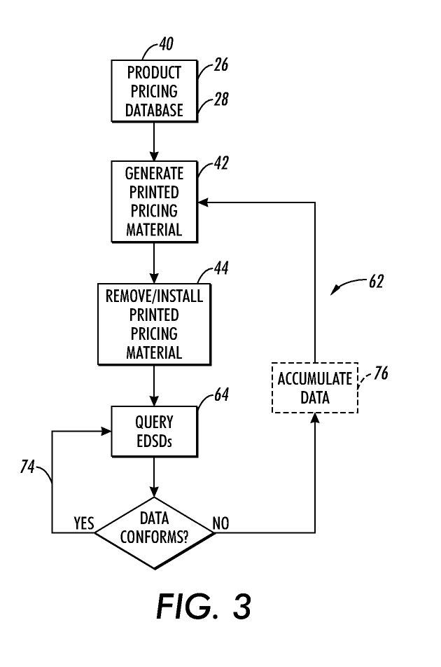

With reference to FIG. 1, a first embodiment of the system 10 includes a computer 20 and a printer 22, generally located in a central location, and at least one portable EDSD reader 24. A database 18 is created 26 and maintained 28 (FIG. 3) on the computer 20. The database 18 has a record for each product sold in the store. Each such record generally includes a unique identifier for the product and the current price for the product, and may include a description of the product. In this centralized system 10, the printer 22 and portable EDSD readers 24 are in communication with the central computer 20, with the central computer 20 controlling the printing of the printed pricing materials 14 and storing data read by the EDSD readers 16. The system 10 may also include one or more portable printers 30 that are in communication with the central computer 20, either directly or via one of the portable EDSD readers 24.

The media 32 used for the printed pricing material 14 includes any paper, card stock, plastic sheet, etc., on which pricing information may be printed. As previously explained, the media 32 must be EDSD enabled. “EDSD enabled media” is hereby defined to be media having an EDSD 12 that is embedded in, formed on, or attached thereto. Accordingly, printers 22, 22′, 30 used to prepare printed pricing material 14 include either an EDSD reader 16, positioned to read identification information stored on the media EDSD 12, or an EDSD reader/encoder device 34 positioned to encode data on the media EDSD 12. If the EDSD 12 of the media 32 used in the printer 22, 22′, 30 is read only, the printer 22, 22′, 30 may include an EDSD reader 16. If the memory of the EDSD 12 of the media 32 used in the printer 22, 22′, 30 may be encoded, the printer 22, 22′, 30 will include an EDSD reader/encoder device 34.

Many conventional inventory control systems use a bar code scanner to determine the identity of products in the inventory. However, bar code scanners require an unobstructed line-of-site to read a bar code. If the product is positioned such that the bar code attached thereto is obstructed by other products, shelving, walls, etc., the bar code reader cannot read the bar code. The portable EDSD reader 24 senses and reads an EDSD 12 when the portable EDSD reader 24 is in range of the EDSD 12, no matter how the EDSD 12 is oriented with regard to the portable EDSD reader 24. As a store employee simply carries the portable EDSD reader 24 throughout the store, the portable EDSD reader 24 communicates with each one of the EDSDs 12 in the range of the reader without any user intervention.

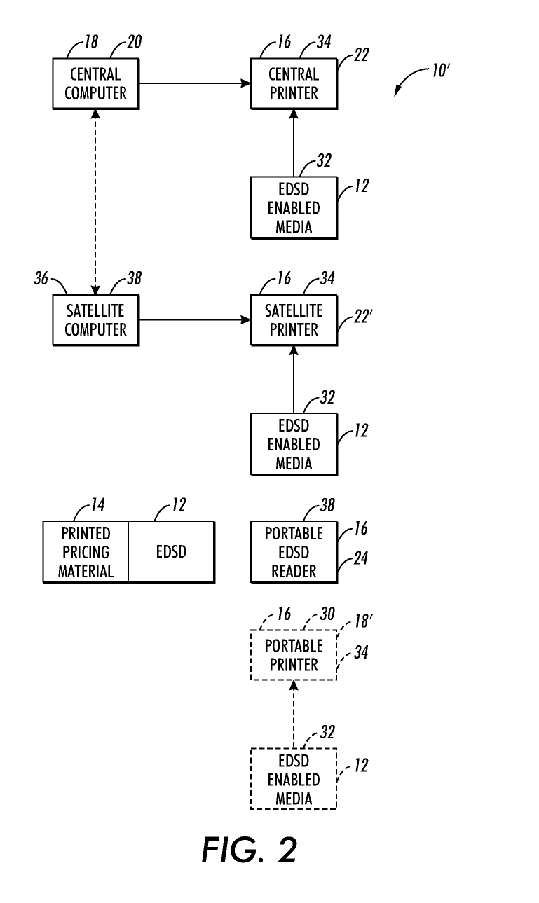

With reference to FIG. 2, a second embodiment of the system 10′ also includes a central computer 20 and a central printer 22, having a database 18 of the type described previously. This decentralized system 10′ may include one or more satellite computers 36 having a “slave database” 38 (a copy of database 18) stored therein. The central computer 20 and satellite computer(s) 36 control the printers 22, 22′ that are connected to them. Slave database 38 may also be stored in one or more portable printers 30 and the portable EDSD reader 24, with the slave databases 38 being accessed during operation of the respective device. The slave databases 38 are synchronized 40 with the master database 18 whenever the master database 18 is revised or updated.

It should be appreciated that the centralized system 10 and the decentralized system 10′ may be combined to produce a number of different hybrid systems. For example some of the satellite computers 36, portable printers 30 or portable EDSD readers 24 may be in communication with the central computer 20 and therefore not require slave databases 38.

With reference to FIG. 3, the system 10, 10′ facilitates verifying that the product pricing displayed at a retail store is correct and up-to-date. As described previously, the system 10, 10′ includes a central computer 20 having a product pricing database 18 with a record for each product sold in the store. Many such stores have central computers with an inventory database that may be used for the product pricing database or may be adapted for use as the product pricing database. Other stores may have to create 26 a product pricing database 18. Each record of the product pricing database 18 includes at least a unique identifier for the product and the current price for the product. Changes in the price of a product are implemented by changing 28 the price data in the record associated with the product. Users may find it advantageous to implement price changes on a periodic basis rather than on a continuous basis to more efficiently maintain the product pricing database.

Printed pricing material 14 generated in accordance with the following procedure may be used in any manner that is conventional for such material. For example, the printed pricing material may be installed 44 on the shelf containing the product or affixed to the product. When printed pricing material 14 for each product is generated 42, the price printed on the printed pricing material is obtained 46 from the price data field of the record in the product pricing database 18 for that product, and this price is printed 48 on the media 32. If the EDSD 12 of the media 32 used in the printer 22, 22′, 30 for generating the printed pricing material 14 is read only, the EDSD reader 16 of the printer 22, 22′, 30 reads 50 the identification data stored in the EDSD 12, and the identification data is stored 52 in a field of the record for the product. In a centralized system 10, the identification data is transmitted to the central computer 20 for storage in the product pricing database 18. In a decentralized system, the identification data is stored in the slave database 38 of the printer 22′ or satellite computer 36 for transfer to the master database 18 upon synchronization 40.

If the memory of the EDSD of the media used in the printer may be encoded, the EDSD reader/encoder device retrieves 54 the unique identifier of the product from the master database 18 or a slave database 38 and encodes 56 the identifier in the EDSD. The EDSD reader/encoder device may also retrieve 58 the price data of the product from the master database 18 or a slave database 38 and encode 60 the price data in the EDSD.

The printed pricing material is maintained 62 by having at least one employee walk through the store on a periodic basis with a portable EDSD reader 24. As the employee passes through the store, the portable EDSD reader 24 queries 64 the memory of each EDSD 12 that comes within range of the portable EDSD reader 24. If the EDSD 12 is a read only EDSD or contains only identification data, the portable EDSD reader 24 reads 66 the identification data stored therein and queries 68 the database record for the product associated with the identification data to obtain the price data associated with the product. This price data is displayed 70 on the portable EDSD reader 24, allowing the employee to compare 72 the current price data (displayed on the portable EDSD reader) to the price information displayed on the posted printed pricing material 14. If the price information displayed on the posted printed pricing material is the same as the current price data displayed on the portable EDSD reader 24, no action is required and the employee continues 74 to pass through the store. If the price information displayed on the posted printed pricing material is not the same as the current price data displayed on the portable EDSD reader 24, new printed pricing material is generated 42, and the incorrect printed pricing material is removed and replaced 44 with the new printed pricing material 14.

If the employee does not have a portable printer 30, or if the printed pricing material 14 is of a type that cannot be produced by a portable printer 30, the portable EDSD reader 24 accumulates 76 data regarding the printed pricing material 14 that must be replaced. When the portable EDSD reader 24 is synchronized 40 with the central computer 20 or a satellite computer 36 having an appropriate printer 22, 22′, the printed pricing material 14 is generated 42, and the incorrect printed pricing material is removed and replaced 44 with the new printed pricing material 14.

If the printed pricing material EDSD 12 also contains price data, the portable EDSD reader 24 reads 78 the identification data and also reads 80 the price data. The price data is associated 82 with the identification data and the database record is queried 84 to obtain the price data for the product. The price data read from the EDSD is then compared 86 to the price data retrieved from the database. If the price data stored in the posted printed pricing material EDSD 12 is the same as the current price data stored in the master database 18 or a slave database 38, no action is required and the employee continues 74 to pass through the store. If the price information stored in the posted printed pricing material EDSD 12 is not the same as the current price data, new printed pricing material 14 is generated 42 with a portable printer 30 or a printer 22, 22′ attached to the central computer 20 or a satellite computer 36 as described above.

If the database 18 includes data regarding promotional sales pricing, the system may also query the expiration date for the promotional campaign to determine if the price information on the printed pricing material has expired.

In one variation, multiple portable EDSD readers 24 are located in shopping carts used in the store. As the shoppers walk through the store, the portable EDSD readers 24 in the shopping carts verify the accuracy of all the printed pricing material 14 that pass within the range of the portable EDSD reader 24. When it is determined one of the printed pricing materials 14 is outdated, the identification information and location of the printed pricing material 14 is recorded. This data may be transmitted to the central computer 20 through a wireless system or the portable EDSD readers 24 in the shopping carts may be periodically synchronized 40 with the master database 18. Replacement printed pricing material 14 could then be generated in a batch, along with the precise location for installation.

In another variation, EDSD readers 16 may be fixedly positioned such that the entire retail floor is within the range of at least one EDSD reader 16. In this case the system 10. 10′ would regularly check the entire store for outdated printed pricing material.

The system 10, 10′ may be extended with a locating system that determines the location of a specific tag more accurately within the scope of the reader. Such a device is disclosed in U.S. patent application Ser. No. 11/352,674, which is incorporated by reference in its entirety. Using this information, the system 10, 10′ could provide a more accurate location of the printed pricing material that needs to be replaced or removed.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A system for maintaining displayed pricing at retail stores, the system comprising:
a computer including a database having a record of each product for which displayed pricing will be maintained, each such record including a unique identifier for the product and the current price for the product;
a printer in communication with the computer, the printer being adapted to generate printed pricing material on EDSD enabled media;
an EDSD reader or an EDSD reader/encoder associated with the printer; and
at least one portable EDSD reader.

2. The system of claim 1 further comprising at least one portable printer.

3. The system of claim 2 wherein the EDSD reader or EDSD reader/encoder associated with the printer, the portable EDSD reader and the portable printer are in communication with the computer.

4. The system of claim 1 further comprising:
at least one satellite computer having a copy of the database stored therein;
a satellite printer in communication with the satellite computer, the satellite printer being adapted to generate printed pricing material on EDSD enabled media; and
an EDSD reader or an EDSD reader/encoder associated with the satellite printer.

5. The system of claim 4 wherein the portable EDSD reader has a copy of the database stored therein.

6. The system of claim 4 further comprising at least one portable printer, the portable printer having a copy of the database stored therein.

7. The system of claim 1 further comprising a locating system adapted to determine the location of a specific EDSD.

8. A method of maintaining displayed pricing at retail stores, the method comprising:
maintaining a product pricing database, the database including a record of each product for which displayed pricing will be maintained, each such record including a unique identifier for the product and a current price for the product;
generating a printed pricing material including
obtaining the current price from the product record in the product pricing database,
printing the current price on EDSD enabled media, and
associating an identifier stored in the EDSD with the product; and
installing the printed pricing material in the store.

9. The method of claim 8 wherein associating the identifier comprises:
reading the identifier stored in the EDSD with an EDSD reader device associated with the printer; and
storing the identifier in a field of the product record.

10. The method of claim 8 wherein associating the identifier comprises:
retrieving a unique identifier of the product from the database; and
encoding the product identifier in the EDSD.

11. The method of claim 10 wherein associating the identifier further comprises:
retrieving the current price of the product from the database; and
encoding the current price in the EDSD.

12. The method of claim 8 further comprising:
passing a portable EDSD reader through the store;
querying each EDSD that comes within range of the portable EDSD reader;
querying the product pricing database for the current price of the products associated with the EDSD identifiers;
comparing the current price of the products to the price on the installed printed pricing materials; and
generating new printed pricing materials if the price printed on the installed printed pricing materials is not the same as the current price for the product.

13. The method of claim 8 further comprising:
passing a portable EDSD reader through the store;
reading the identifier stored in each EDSD that comes within range of the portable EDSD reader;
querying the product pricing database for the current price of the products associated with the EDSD identifiers;
displaying the current product prices on the portable EDSD reader;
visually comparing the current price of the products to the price on the installed printed pricing materials; and
generating new printed pricing materials if the price printed on the installed printed pricing materials is not the same as the current price for the product.

14. The method of claim 8 further comprising:
passing a portable EDSD reader through the store;
reading the identifier and price stored in each EDSD that comes within range of the portable EDSD reader;
querying the product pricing database for the current price of the products associated with the EDSD identifiers;
comparing the current price of the products to the price stored in the EDSDs of the installed printed pricing materials; and
generating new printed pricing materials if the price printed on the installed printed pricing materials is not the same as the current price for the product.

15. A system for maintaining displayed pricing at retail stores, the system comprising:
a computer including a database having a record of each product for which displayed pricing will be maintained, each such record including a unique identifier for the product and the current price for the product;
a printer in communication with the computer, the printer being adapted to generate printed pricing material on EDSD enabled media;
an EDSD reader or an EDSD reader/encoder associated with the printer, the EDSD reader or the EDSD reader/encoder being in communication with the computer;
at least one portable EDSD reader in communication with the computer; and
at least one portable printer.

16. The system of claim 15 wherein the portable printer is in communication with the computer.

17. A system for maintaining displayed pricing at retail stores, the system comprising:
a computer including a database having a record of each product for which displayed pricing will be maintained, each such record including a unique identifier for the product and the current price for the product;
a printer in communication with the computer, the printer being adapted to generate printed pricing material on EDSD enabled media;
an EDSD reader or an EDSD reader/encoder associated with the printer, the EDSD reader or the EDSD reader/encoder being in communication with the computer; and
at least one portable EDSD reader, the portable EDSD reader having a copy of the database stored therein.

18. The system of claim 17 further comprising:
at least one satellite computer having a copy of the database stored therein; and
a satellite printer in communication with the satellite computer, the satellite printer being adapted to generate printed pricing material on EDSD enabled media;
an EDSD reader or an EDSD reader/encoder associated with the satellite printer, the EDSD reader or the EDSD reader/encoder being in communication with the satellite computer

19. The system of claim 17 further comprising at least one portable printer, the portable printer having a copy of the database stored therein.
